(19) United States
(12) Patent Application Publication
(10) Pub. No.: US 2005/0021321 A1
(43) Pub. Date: Jan. 27, 2005

(54) Apparatus, method, and program for estimation of biological electromagnetic compatibility

(75) Inventors: Shoji Mochizuki, Tokyo (JP); Souichi Watanabe, Tokyo (JP); Yukio Yamanaka, Tokyo (JP); Maso Taki, Tokyo (JP); Hiroshi Shirai, Tokyo (JP)

Correspondence Address: LORUSSO, LOUD & KELLY, 3137 Mount Vernon Avenue, Alexandria, VA, 22305, US

(73) Assignee: COMMUNICATIONS RESEARCH LABORATORY, INDEPENDENT ADMINISTRATIVE INSTITUTION

(21) Appl. No.: 10/760,376

(22) Filed: Jan. 21, 2004

(30) Foreign Application Priority Data
Jul. 22, 2003 (JP) 277626

(51) Int. Cl. G06G 7/48; G06G 7/58

(52) U.S. Cl. 703/11

(57) ABSTRACT

In an apparatus, a method, and a program for estimation of biological electromagnetic compatibility, model data of a scattering body and an electromagnetic wave radiation source, data for prescribing a range to which an MoM including the electromagnetic wave radiation source is applied and a range to which a scattered field type FDTD method including the scattering body and the range to which the MoM is applied, and the like are previously prepared. The distribution of a current distributed by a voltage fed to the electromagnetic wave radiation source is determined by the MoM, incident electromagnetic fields incident on the respective grids in the scattering body are determined using the resultant distribution of the current, an electromagnetic field scattered from the scattering body is determined from the resultant incident electromagnetic field by the scattered field type FDTD method, electromotive forces induced in the respective segments of the electromagnetic wave radiation source are determined from the resultant scattered electromagnetic field, and further the distribution of the current is determined again in consideration of the induced electromotive forces. The above processing steps are repeated until the electromagnetic fields incident on the respective grids in the scattering body, and the like are converged. With the above operation, the biological electromagnetic compatibility can be estimated by executing calculations simply without depending on the distance between the electromagnetic wave radiation source and the scattering body.

### BACKGROUND OF THE INVENTION

1. Field of the Invention

The present invention relates to an apparatus, a method, and a program for estimation of biological electromagnetic compatibility which can be applied to the simulation of a specific absorption rate (SAR) of an electromagnetic wave in a human body that is an electromagnetic wave protection indicating value when, for example, a mobile phone is used.

2. Description of the Related Art

There is conventionally a finite-difference time-domain (hereinafter, abbreviated as “FDTD”) method in a time domain as a method of analyzing a specific absorption rate of an electromagnetic wave in a human body when a mobile phone is used. Further, to construct a model of an antenna portion and to analyze the model more accurately, there is recently studied a hybrid technique of a method of moments (hereinafter, abbreviated as “MoM”) in a frequency domain and the FDTD in the time domain as disclosed in, for example, Mohab A. Mangoud and Raed A. Abd-Alhameed and Peter S. Excell, “Simulation of Human Interface with Mobile Telephones Using Hybrid Techniques Over Coupled Domains”. IEEE Trans. Micrwave Theory Tech., Vol. 48, no, 11, pp. 2014-2021, 2000. The conventional hybrid technique is premised on a model in which the MoM in the frequency domain is applied to an electromagnetic wave radiation source (for example, an antennal of a mobile phone) and the FDTD method in the time domain is applied to a scattering body such as a living body tissue and the like.

The distribution of a SAR, and the like are determined from the distribution of an electric field in a scattering body (human body) by converging the distribution of a current on an electromagnetic wave radiation source obtained by the MoM and the distribution of an electromagnetic field in the scattering body obtained by the FDTD method by alternately and repeatedly calculating the distribution of the current on the electromagnetic wave radiation source and the distribution of the electromagnetic field in the scattering body. Here, the region, which includes the electromagnetic wave radiation source and is calculated by the MoM, is connected to the region, which includes the scattering body and is calculated by the FDTD method, by assuming an equivalent electromagnetic flow on a virtual curved close surface corresponding to the boundary between the respective regions.

However, when the equivalent electromagnetic flow on the virtual curved close surface is introduced, a long calculation step (program) is necessary to calculate the parameters determined by repeating the calculations described above, and the amount of the calculations is also increased. Accordingly, a long time is necessary until the SAR distribution and the like are determined, or an information processing apparatus and the like having a high processing capability must be used. When mobile radio terminals such as a mobile phone and the like are made more complex in structure and employ higher technologies in future, an increase in the number of parameters and the amount of calculations put an enormous load on the mobile radio terminals.

Further, since the region, which includes the electromagnetic wave radiation source and is calculated by the MoM, is connected to the region, which includes the scattering body and is calculated by the FDTD method, through the virtual close curved surface, when the distance between the electromagnetic wave radiation source and the scattering body is short, there is a case in which the result of analysis cannot be obtained. For example, when a mobile phone is used in contact with an ear and when gripped with a hand, the result of analysis may not be obtained at a position which is located near to the ear or to the surface of the hand.

Accordingly, there are desired an apparatus, a method, and a program for estimation of biological electromagnetic compatibility capable of estimating a biological electromagnetic compatibility by executing calculations simply without depending on the distance between an electromagnetic wave radiation source and a scattering body.

### SUMMARY OF THE INVENTION

To solve the above problems, an apparatus for estimation of biological electromagnetic compatibility of a first invention comprises: (1) a model data storing means including at least scattering body model data, in which a scattering body corresponding to a living body is divided into grids and the specific dielectric constant and the conductivity of each grid is prescribed, electromagnetic wave radiation source model data, in which an electromagnetic wave radiation source is divided into segments each having a unit length, data showing the positional relationship between the scattering body and the electromagnetic wave radiation source, data for prescribing a region to which a MoM including the electromagnetic wave radiation source is applied, and data for prescribing the region to which a scattered field type FDTD method including the region to which the scattering body and the MoM are applied; (2) a first MoM processing means for determining the distribution of a current on the electromagnetic wave radiation source distributed by a voltage fed to the electromagnetic wave radiation source by the MoM; (3) a MoM/FDTD coupling means for determining incident electromagnetic fields incident on the respective grids in the scattering body from the electromagnetic wave radiation source using the distribution of the current on the electromagnetic wave radiation source determined above; (4) an FDTD method processing means for determining the electromagnetic field scattered from the scattering body by a scattered field type FDTD method from the incident electromagnetic field determined above; (5) an FDTD/MoM coupling means for determining electromotive forces induced in the respective segments constituting the electromagnetic wave radiation source from the scattered electromagnetic field determined above; (6) a second MoM processing means for determining the distribution of the current on the electromagnetic wave radiation source distributed by the voltage fed to the electromagnetic wave radiation source and by the induced electromotive forces in the respective segments by the MoM; and (7) a repeat control means for repeating the processing steps executed by the MoM/FDTD coupling means, the FDTD method processing means, the FDTD/MoM coupling means, and the second MoM processing means until the results of the calculations executed at the processing steps are converged.

A method for estimation of biological electromagnetic compatibility of a second invention comprises: (1) a step of previously storing model data including at least scattering body model data, in which a scattering body corresponding to a living body is divided into grids and the specific dielectric constant and the conductivity of each grid is prescribed, electromagnetic wave radiation source model data, in which an electromagnetic wave radiation source is divided into segments each having a unit length, data showing the positional relationship between the scattering body and the electromagnetic wave radiation source, data for prescribing a region to which a MoM including the electromagnetic wave radiation source is applied, and data for prescribing the region to which a scattered field type FDTD method including the region to which the scattering body and the MoM are applied; (2) a first MoM processing step of determining the distribution of a current on the electromagnetic wave radiation source distributed by a voltage fed to the electromagnetic wave radiation source by the MoM; (3) a MoM/FDTD coupling step of determining incident electromagnetic fields incident on the respective grids in the scattering body from the electromagnetic wave radiation source using the distribution of the current on the electromagnetic wave radiation source determined above; (4) an FDTD method processing step of determining the electromagnetic field, scattered from the scattering body by a scattered field type FDTD method, from the incident electromagnetic field determined above; (5) an FDTD/MoM coupling step of determining electromotive forces induced in the respective segments constituting the electromagnetic wave radiation source from the scattered electromagnetic field determined above; (6) a second MoM processing step of determining the distribution of the current on the electromagnetic wave radiation source distributed by the voltage fed to the electromagnetic wave radiation source and by the induced electromotive forces in the respective segments by the MoM; and (7) a repeat control step of repeating the steps executed at the MoM/FDTD coupling step, the FDTD method processing step, the FDTD/MoM coupling step, and the second MoM processing step until the results of the calculations executed at the processing steps are converged.

A program for estimation of biological electromagnetic compatibility of a third embodiment includes codes described in the program according to which a computer can execute the respective data and the respective steps of the method for estimation of biological electromagnetic compatibility of the second embodiment.

As described above, according to the present invention, there can be provided the apparatus, the method, and the program for estimation of biological electromagnetic compatibility capable of estimating the biological electromagnetic compatibility by executing calculations simply without depending on the distance between the electromagnetic wave radiation source and the scattering body.

### BRIEF DESCRIPTION OF THE DRAWINGS

FIG. 1 is an explanatory block diagram showing a program for estimation of biological electromagnetic compatibility of a first embodiment;

FIG. 2 is an explanatory view explaining the positional relationship among a MoM region, an FDTD region, a scattering body, and a electromagnetic wave radiation source of the first embodiment;

FIG. 3 is flowchart showing an estimation sequence of the first embodiment for estimating the biological electromagnetic compatibility;

FIG. 4 is an explanatory view showing an image of MoM processing and MoM/FDTD coupling processing executed in the first embodiment;

FIG. 5 is an explanatory view showing an image of an FDTD method processing and FDTD/MoM coupling processing executed in the first embodiment; and

FIG. 6 is an explanatory view showing an image of the MoM processing reflecting induced electromotive forces of the first embodiment.

### DESCRIPTION OF THE PREFERRED EMBODIMENTS

Preferable embodiments of an apparatus, a method, and a program for estimation of biological electromagnetic compatibility according to the present invention will be described below in detail with reference to the drawings.

Embodiment 1

FIG. 1 is an explanatory view showing a file structure of a program P for estimation of biological electromagnetic compatibility in a first embodiment. The program P for estimation of biological electromagnetic compatibility is installed on an information processing device D such as a personal computer, and the like, thereby an apparatus for estimation of biological electromagnetic compatibility of the first embodiment is arranged.

Note that the apparatus for estimation of biological electromagnetic compatibility may be arranged such that the program P for estimation of biological electromagnetic compatibility is divided into a plurality of portions mounted on different information processing devices and data is given to and received from the information processing devices. The program P for estimation of biological electromagnetic compatibility may be installed by being taken out from a recording medium or may be downloaded from other device.

In FIG. 1, the program P for estimation of biological electromagnetic compatibility in the first embodiment is composed of model data P1, a MoM processing routine P2, a MoM/FDTD coupling routine P3, an FDTD method processing routine P4, an FDTD/MoM coupling routine P5, a repeat control routine P6, and an output value calculation routine P7.

Note that it is preferable that the program P for estimation of biological electromagnetic compatibility is arranged such that only the model data P1 can be replaced. That is, it is preferable that the program P is arranged to cope with a model data P1 replaced with a previous one and a model data P1 input later (by being read from a recording medium or down loaded).

Further, the respective processing routines P2, . . . , P7 are installed on the information processing device, and when a CPU is placed in an executable state, these routines act as means for executing the functions of the CPU.

The model data P1 is composed of electromagnetic wave radiation source model data P11, scattering body model data P12, region model data P13, and the like.

The electromagnetic wave radiation source model data P11 is data for prescribing the shape of an electromagnetic wave radiation source, for example, an antennal and the like and the power feed point thereof. When the electromagnetic wave radiation source is composed of, for example, a dipole antenna, the electromagnetic wave radiation source model data P11 is composed the position data of respective segments of the dipole antenna, the segments being obtained by dividing the dipole antenna and having a predetermined unit length, the data of an antenna diameter (or the data of an antenna radius), the position data of the power feed point, the data of excitation input to the power feed point (frequency, amplitude, power, etc.), and so on.

The scattering body model data P12 is data for prescribing a scattering body, for example, the head portion of a human body which is used to analyze the influence of an electromagnetic wave applied thereto from the electromagnetic wave radiation source. When the scattering body is, for example, the head portion of the human body, the scattering body model data P12 is composed of the position data of respective voxels (grids) obtained by dividing, for example, the head portion into segments each having a size of 2×2×2 [mm], medium data (data of the specific dielectric constant and the conductivity of a medium), and the like.

Note that the distance between the electromagnetic wave radiation source and the scattering body may be set by prescribing the position of the electromagnetic wave radiation source on a coordinate system common to both the models of the radiation source and the scattering body by the electromagnetic wave radiation source model data P11 and by prescribing the position of the scattering body on a coordinate system common to both the models also by the scattering body model data P12. Further, the distance between the electromagnetic wave radiation source and the scattering body may be set by prescribing the position of the electromagnetic wave radiation source on a coordinate system of the model of the radiation source by the electromagnetic wave radiation source model data P11 as well as prescribing the position of the scattering body on a coordinate system of the model of the scattering body by the scattering body model data P12 and by separately prescribing the distance between both the coordinate systems separately.

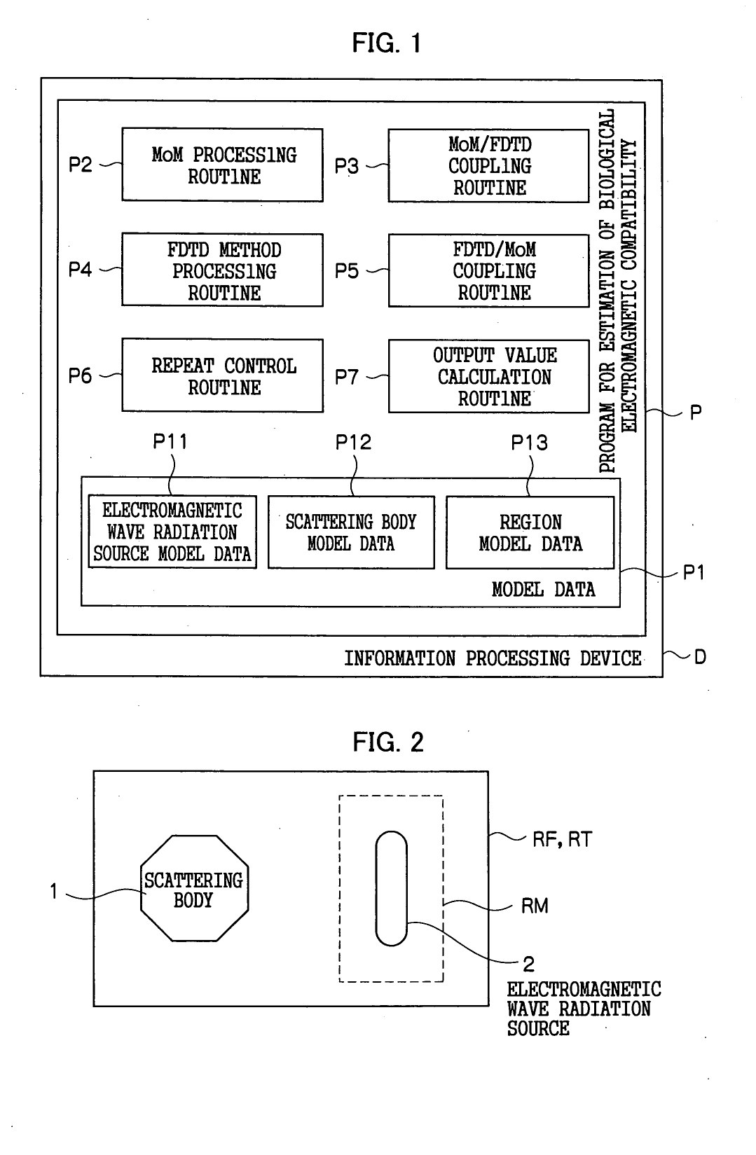

The region model data P13 is data for prescribing a analyzing region (overall region), a region to which a MoM is applied (hereinafter, referred to as “MoM region”), and a region to which an FDTD method is applied (hereinafter, referred to as “FDTD region”). In the first embodiment, the MoM region RM is set in the FDTD region RF as shown in FIG. 2. Further, the FDTD region RF is caused to coincide with the overall region RT. Further, the scattering body 1 (the data thereof) exists in the FDTD region RF, and the electromagnetic wave radiation source 2 (the data thereof) is set in the MoM region RM.

The MoM processing routine P2 determines the distribution of a current on the electromagnetic wave radiation source 2 from a voltage fed from the electromagnetic wave radiation source 2 and from induced electromotive forces which will be described later. The routine described in the literature “Numerical Electromagnetics Code, LLNL, 1981” can be applied as the MoM processing routine P2. Note that a MoM processing routine for determining the distribution of the current on the electromagnetic wave radiation source 2 from the voltage fed from the electromagnetic wave radiation source 2 and a MoM processing routine for determining the distribution of the current on the electromagnetic wave radiation source 2 from the voltage fed from the electromagnetic wave radiation source 2 and the induced electromotive forces may be separately prepared.

The MoM/FDTD coupling routine P3 converts the result of processing executed by the MoM (the distribution of the current on the electromagnetic wave radiation source 2) into input data in the FDTD method (incident electromagnetic field on the scattering body 1).

The FDTD method processing routine P4 determines a scattered electromagnetic field (scattered field) in a steady state from the scattering body 1 in correspondence to the incident electromagnetic field on the scattering body 1 according to a scattered field type FDTD method. The scattered field type FDTD method is described in, for example, “Analysis of Electromagnetic Field and Antenna by FDTD Method”, Tohru UNO, Corona, 1998.

The FDTD/MoM coupling routine P5 converts the result of processing executed by the FDTD method (scattered field) into data (induced electromotive forces) input to the MoM.

The repeat control routine P6 causes calculations to be repeatedly executed by the MoM and the FDTD method as well as finishes the execution of the repeated calculations when it can be confirmed that the distribution of the current on the electromagnetic wave radiation source 2, the scattered field from the scattering body 1, and the electromagnetic field in the scattering body 1 have been converged.

When the repeated calculations are finished, the output value calculation routine P7 calculates the value of the output characteristic (for example, specific absorption rate) which is set or has been set and displays the value on a display unit or outputs the value from a printer and the like.

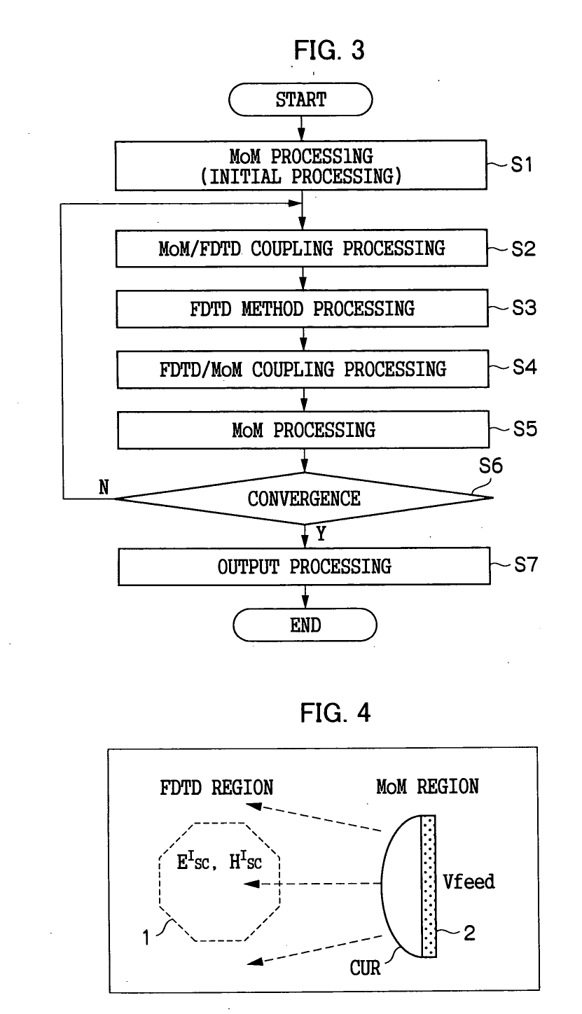

Next, the method for estimation of biological electromagnetic compatibility of the first embodiment executed by the model data and the processing routines described above will be explained with reference to the flowchart of FIG. 3. Note that the model data P1 is already set before the processing steps shown in FIG. 3 starts.

Step S1: First, it is assumed that other wave source and scattering body do not exist inside and outside of the MoM region RM, that is, it is assumed that the MoM region RM is placed in a free space, and the distribution of a current CUR (refer to FIG. 4) on the electromagnetic wave radiation source 2 that is created by a fed voltage V_{feed} is determined by the MoM processing routine P2.

Step S2: Next, the electromagnetic fields (E^{I}_{SC}, H^{I}_{SC}) which are incident on the respective grids in the scattering body 2 of the FDTD region RF from the electromagnetic wave radiation source 2, are determined by the MoM/FDTD coupling routine P3 using the distribution of the current CUR on the electromagnetic wave radiation source 2 (refer to FIG. 4). Here, the upper suffix “I” shows an incident field, and the lower suffix SC shows the scattering body 1. At this time, the information, which is necessary to the MoM region RM and must be transferred thereto, is the amplitudes and phases of the respective vector components of the incident fields (E^{I}_{SC}, H^{I}_{SC}) in the FDTD region RF. Note that, to determine the phases, the reference positions of the phases are predetermined.

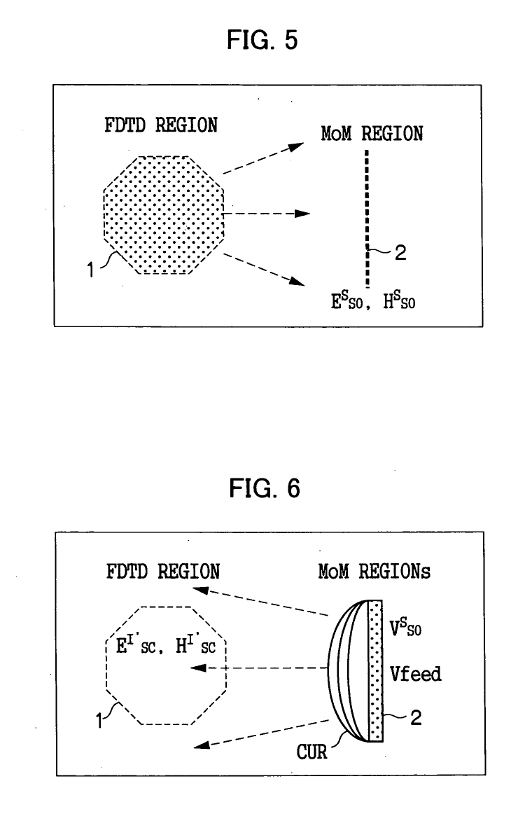

Step S3: The steady state of the scattered field in the FDTD region RF including the MoM region RM is calculated by the FDTD method processing routine P4 in consideration of the incident fields (E^{I}_{SC}, H^{I}_{SC}) obtained at step S2 (refer to FIG. 5). At this time, the above calculation is executed assuming that the electromagnetic wave radiation source 2 does not exist in the MoM region, that is, the MoM region RM is placed in a free space. With the above operation, the scattered fields (E^{S}_{SO}, H^{S}_{SO}), which correspond to the position in the MoM region RM where the electromagnetic wave radiation source 2 exists, are determined. Here, the upper suffix “S” shows the scattered field, and the lower suffix SO shows the electromagnetic wave radiation source 2.

Step S4: The amplitudes and the phases of the electromotive forces V^{S}_{OS} (electric fields of components in a segment direction×length of segments) induced in the respective segments constituting the electromagnetic wave radiation source 2 in the MoM region RM are determined by the FDTD/MoM coupling routine P5 from the scattered fields (E^{S}_{SO}, H^{S}_{SO}) obtained at step S3 (refer to FIG. 5). At this time, the information, which is necessary to the MoM region RM and must be transferred thereto, is the electromotive forces and the phases of the respective segments. The phases are phases which are viewed from the predetermined reference positions described at step S2.

Step S5: The distribution of the current CUR, which is newly induced on the electromagnetic wave radiation source 2 in consideration of the induced electromotive forces V^{S}_{SO} obtained at step S4 and the fed voltage V_{feed} is determined by the MoM processing routine P2 (FIG. 6). However, it is assumed also in this case where the electromagnetic wave radiation source 2 is placed in a free space.

Step S6: Each time step S5 is finished, it is determined by the repeat control routine P6 whether or not the internal electromagnetic field of the scattering body 1, the scattered fields (E^{S}_{SO}, H^{S}_{SO}) scattered to the respective segments of the electromagnetic wave radiation source 2, and the distribution of the current CUR on the electromagnetic wave radiation source 2 are converged, and if any one of the parameters is not converged, the process returns to step S2, whereas when all the parameters are converged, the process goes to step S7. Here, whether or not a certain parameter is converged means whether or not the distance between a previous parameter and a present parameter (sum of squares of respective parameter elements) is equal to or less than a predetermined threshold value.

Step S7: The type (for example, specific absorption rate) of the output characteristics set by an operator before the above processing is started, is captured by the output value calculation routine P7 or the type (for example, specific absorption rate) of the output characteristics set by the operator when the processing at step S6 is finished, is captured thereby (FIG. 3 shows the latter case), and the value of the type of the output characteristics is displayed on the display unit or output from the printer and the like.

According to the first embodiment, when the constituting method of the MoM and the FDTD method is applied, the MoM region is coupled with the FDTD region by the introduction of the scattered type FDTD method using the electromagnetic field, as incident field, radiated from the electromagnetic wave radiation source excited in the free space as well as the FDTD region is coupled with the MoM region by determining the electromotive forces (electric fields of the components in the segment direction×the length of the segments) induced from the scattered field on the segments of the electromagnetic wave radiation source obtained by the scattered field type FDTD method. Accordingly, an increase in the steps and the amount of calculations (programs), which are necessary to calculate the parameters used in the calculations repeated to obtain the steady state of the biological electromagnetic compatibility, can be suppressed.

This means that when, for example, the length of the segments in the electromagnetic wave radiation source and the size of the grids of the scattering body are set similar to conventional ones, the calculations can be executed at a higher speed and an information processing device having a lower capability can be employed. Further, this means that even if the length of the segments in the electromagnetic wave radiation source and the size of the grids of the scattering body are made smaller than those of the conventional ones on the contrary to improve the accuracy of the result of processing, the calculations can be sufficiently executed actually.

Further, even if mobile radio terminals such as a mobile phone and the like are made more complex in structure and employ more advanced technologies hereinafter, since the calculations can be executed by decreasing the length of the segments in the electromagnetic wave radiation source and the size of the grids of the scattering body, the result of assumption of the biological electromagnetic compatibility can be obtained.

Furthermore, since the MoM region is set in the FDTD region, even if the distance between the electromagnetic wave radiation source and the scattering body is very short as in such a case where a mobile phone is used in contact with an ear or is gripped with a hand, the result of estimation of the biological electromagnetic compatibility can be obtained.

Embodiment 2

Although reference is made to a modified embodiment also in the explanation of the first embodiment, a modified embodiment can be further exemplified as an embodiment 2 as described below.

The scattering body is not limited to the head portion of the human body and may be other portion such as a portion around a heart, and the like or may be other living body. Further, the electromagnetic wave radiation source is not limited to the dipole antenna and may be antennas formed in other shapes such a loop antenna, helical antenna, and the like, and further may be a cable, printed circuit board (or its wiring pattern) and the like that radiate an electromagnetic wave while they do not intend to have a function as an antenna.

Although the embodiment 1 shows the case in which convergence is determined in comparison with the threshold value, it may be determined when the number of repeated calculations (number of repetition of steps S2 to S5) reaches a predetermined number of times.

Although the embodiment 1 shows the fixed model data that employs each only one set of the scattering body and the electromagnetic wave radiation source, the present invention can be also applied to model data including a plurality of models each employing at least two scattering bodies and at least two electromagnetic wave radiation sources. In the model data of the scattering bodies, the scattering bodies may have a different shape and a different voxel size. Likewise, in the model data of the electromagnetic wave radiation sources, the radiation sources may have a different shape and segment length. Convergence is determined by parameters such as the scattered electromagnetic fields in the scattering bodies, the distributions of currents on the electromagnetic wave radiation sources, and the like.

In the explanation of the embodiment 1, the respective processing steps are prepared as software that is executed by the CPU of the information processing device such as the personal computer and the like. However, the processing steps may be partly or entirely executed by hardware composed of logic circuits and the like.

### INDUSTRIAL APPLICABILITY

The apparatus, the method, and the program for estimation of biological electromagnetic compatibility according to the present invention can be used to accurately evaluate the amount of exposure of an electromagnetic wave radiated from a mobile radio terminal such as a mobile phone to a living body.

1. An apparatus for estimation of biological electromagnetic compatibility comprising:
model data storing means including at least scattering body model data, in which a scattering body corresponding to a living body is divided into grids and the specific dielectric constant and the conductivity of each grid are prescribed, electromagnetic wave radiation source model data, in which an electromagnetic wave radiation source is divided into segments each having a unit length, data showing the positional relationship between the scattering body and the electromagnetic wave radiation source, data for prescribing a region to which a MoM including the electromagnetic wave radiation source is applied, and data for prescribing the region to which a scattered field type FDTD method including the region to which the scattering body and the MoM are applied;
first MoM processing means for determining the distribution of a current on the electromagnetic wave radiation source distributed by a voltage fed to the electromagnetic wave radiation source by the MoM;
MoM/FDTD coupling means for determining incident electromagnetic fields incident on the respective grids in the scattering body from the electromagnetic wave radiation source using the distribution of the current on the electromagnetic wave radiation source determined above;
FDTD method processing means for determining the electromagnetic field scattered from the scattering body by a scattered field type FDTD method from the incident electromagnetic field determined above;
FDTD/MoM coupling means for determining electromotive forces induced in the respective segments constituting the electromagnetic wave radiation source from the scattered electromagnetic field determined above;
second MoM processing means for determining the distribution of the current on the electromagnetic wave radiation source distributed by the voltage fed to the electromagnetic wave radiation source and by the induced electromotive forces in the respective segments by the MoM; and
repeat control means for repeating the processing steps executed by the MoM/FDTD coupling means, the FDTD method processing means, the FDTD/MoM coupling means, and the second MoM processing means until the results of the calculations executed at the processing steps are converged.

2. The apparatus for estimation of biological electromagnetic compatibility according to claim 1, wherein the repeat control means further includes electromagnetic wave protection indicating value calculation means for calculating an electromagnetic wave protection indicating value from the results of the calculations of the scattered electromagnetic field and the like when it is determined that the results of the calculations have been converged.

3. A method for estimation of biological electromagnetic compatibility comprising:
a step of previously storing model data including at least scattering body model data, in which a scattering body corresponding to a living body is divided into grids and the specific dielectric constant and the conductivity of each grid are prescribed, electromagnetic wave radiation source model data, in which an electromagnetic wave radiation source is divided into segments each having a unit length, data showing the positional relationship between the scattering body and the electromagnetic wave radiation source, data for prescribing a region to which a MoM including the electromagnetic wave radiation source is applied, and data for prescribing the region to which a scattered field type FDTD method is applied, including the region to which the scattering body and the MoM are applied;
a first MoM processing step of determining the distribution of a current on the electromagnetic wave radiation source distributed by a voltage fed to the electromagnetic wave radiation source by the MoM;
a MoM/FDTD coupling step of determining incident electromagnetic fields incident on the respective grids in the scattering body from the electromagnetic wave radiation source using the distribution of the current on the electromagnetic wave radiation source determined above;
a FDTD method processing step of determining the electromagnetic field scattered from the scattering body by a scattered field type FDTD method from the incident electromagnetic field determined above;
a FDTD/MoM coupling step of determining electromotive forces induced in the respective segments constituting the electromagnetic wave radiation source from the scattered electromagnetic field determined above;
a second MoM processing step of determining the distribution of the current on the electromagnetic wave radiation source distributed by the voltage fed to the electromagnetic wave radiation source and by the induced electromotive forces in the respective segments by the MoM; and
a repeat control step of repeating the steps executed at the MoM/FDTD coupling step, the FDTD method processing step, the FDTD/MoM coupling step, and the second MoM processing step until the results of the calculations executed at the processing steps are converged.

4. The method for estimation of biological electromagnetic compatibility according to claim 3, wherein the repeat control step further comprises an electromagnetic wave protection indicating value calculation step of calculating an electromagnetic wave protection indicating value from the results of the calculations of the scattered electromagnetic field and the like when determined that the results of the calculations have been converged.

5. A program for estimation of biological electromagnetic compatibility, comprising codes described in the program according to which a computer can execute the data comprising:
scattering body model data, in which a scattering body corresponding to a living body is divided into grids and the specific dielectric constant and the conductivity of each grid are prescribed, electromagnetic wave radiation source model data, in which an electromagnetic wave radiation source is divided into segments each having a unit length, data showing the positional relationship between the scattering body and the electromagnetic wave radiation source, data for prescribing a region to which a MoM including the electromagnetic wave radiation source is applied, and data for prescribing the region to which a scattered field type FDHD method is applied, including the region to which the scattering body and the MoM are applied, and the steps comprising:
a first MoM processing step of determining the distribution of a current on the electromagnetic wave radiation source distributed by a voltage fed to the electromagnetic wave radiation source by the MoM;
a MoM/FDTD coupling step of determining incident electromagnetic fields incident on the respective grids in the scattering body from the electromagnetic wave radiation source using the distribution of the current on the electromagnetic wave radiation source determined above;
a FDTD method processing step of determining the electromagnetic field scattered from the scattering body by a scattered field type FDTD method from the incident electromagnetic field determined above;
a FDTD/MoM coupling step of determining electromotive forces induced in the respective segments constituting the electromagnetic wave radiation source from the scattered electromagnetic field determined above;
a second MoM processing step of determining the distribution of the current on the electromagnetic wave radiation source distributed by the voltage fed to the electromagnetic wave radiation source and by the induced electromotive forces in the respective segments by the MoM; and
a repeat control step of repeating the steps executed at the MoM/FDTD coupling step, the FDTD method processing step, the FDTD/MoM coupling step, and the second MoM processing step until the results of the calculations executed at the processing steps are converged;

6. The program for estimation of biological electromagnetic compatibility according to claim 5, the repeat control step further comprising;
an electromagnetic wave protection indicating value calculation step of calculating an electromagnetic wave protection indication value from the results of the calculations of the scattered electromagnetic field and the like when determined that the results of the calculations have been converged.
